(19) United States
(12) Patent Application Publication
(10) Pub. No.: US 2020/0326709 A1
(43) Pub. Date: Oct. 15, 2020

(54) METHOD AND DEVICE FOR CONTROLLING RESET OF GIMBAL, GIMBAL, AND UNMANNED AERIAL VEHICLE

(71) Applicant: SZ DJI TECHNOLOGY CO., LTD., Shenzhen (CN)

(72) Inventors: Shuai LIU, Shenzhen (CN); Yingzhi WANG, Shenzhen (CN); Zhendong WANG, Shenzhen (CN)

(21) Appl. No.: 16/911,947

(22) Filed: Jun. 25, 2020

Related U.S. Application Data
(63) Continuation of application No. PCT/CN2017/119774, filed on Dec. 29, 2017.

(51) Int. Cl. G05D 1/00; G03B 15/00; B64D 47/08

(52) U.S. Cl. CPC G05D 1/0094; B64C 39/024; B64D 47/08; G03B 15/006

(57) ABSTRACT

A method for controlling reset of a gimbal includes calculating a difference between a joint angle of the gimbal at a first position and a joint angle of the gimbal at a second position when the gimbal passively rotates from the first position to the second position along a passive rotation direction, and controlling the gimbal to return to the first position from the second position by rotating along a direction opposite to the passive rotation direction if the difference satisfies a first condition, or by rotating along a shortest path or along the direction opposite to the passive rotation direction according to a target sub-region if the difference satisfies a second condition. The first position is located in the target sub-region, which is one of a plurality of sub-regions of a rotation region of the gimbal. The rotation region has a joint angle range larger than 360 degrees.

### CROSS-REFERENCE TO RELATED APPLICATION

This application is a continuation of International Application No. PCT/CN2017/119774, filed on Dec. 29, 2017, the entire content of which is incorporated herein by reference.

### TECHNICAL FIELD

The present disclosure relates to the technical field of gimbal control and, more particularly, to a method and device for controlling reset of a gimbal, a gimbal, and an unmanned aerial vehicle (UAV).

### BACKGROUND

Currently, a gimbal uses a slip ring or a rotating structure having mechanical limits and an angle range greater than 360 degrees to achieve 360-degree shooting during a shooting process. When the rotating structure is used, a rotation region of the gimbal includes a forward rotation region and a backward rotation region. A joint angle of the gimbal for the forward rotation region and a joint angle of the gimbal for the backward rotation region are both greater than 180 degrees and less than 360 degrees, and the mechanical limits are arranged at a maximum joint angle of the forward rotation region and a maximum joint angle of the backward rotation region, such that a joint angle of gimbal for the rotation region of the gimbal is greater than 360 degrees. When rotating the gimbal in a specific direction, sometimes the angle cannot be rotated by 360 degrees. When the gimbal is locked at an angle that cannot be rotated by 360 degrees and is manually pushed to rotate greater than 180 degrees, if the gimbal is reset using a shortest path after releasing the hand, the gimbal collides with the mechanical limit due to the shortest path and cannot be reset.

### SUMMARY

In accordance with the disclosure, there is provided a method for controlling reset of a gimbal including calculating a difference between a joint angle of the gimbal at a first position and a joint angle of the gimbal at a second position in response to the gimbal passively rotating from the first position to the second position along a passive rotation direction, controlling the gimbal to return to the first position from the second position by rotating along a direction opposite to the passive rotation direction in response to the difference satisfying a first condition, and controlling the gimbal to return to the first position from the second position by rotating along a shortest path or along the direction opposite to the passive rotation direction according to a target sub-region in which the first position is located in response to the difference satisfying a second condition. A rotation region of the gimbal has a joint angle range larger than 360 degrees, and the target sub-region is one of a plurality of sub-regions of the rotation region.

Also in accordance with the disclosure, there is provided a device for controlling reset of a gimbal including one or more processors working individually or collectively and a storage device storing program instructions that, when executed by the one or more processors, cause the one or more processors to calculate a difference between a joint angle of the gimbal at a first position and a joint angle of the gimbal at a second position in response to the gimbal passively rotating from the first position to the second position along a passive rotation direction, control the gimbal to return to the first position from the second position by rotating along a direction opposite to the passive rotation direction in response to the difference satisfying a first condition, and control the gimbal to return to the first position from the second position by rotating along a shortest path or along the direction opposite to the passive rotation direction according to a target sub-region in which the first position is located in response to the difference satisfying a second condition. A rotation region of the gimbal has a joint angle range larger than 360 degrees, and the target sub-region is one of a plurality of sub-regions of the rotation region.

Also in accordance with the disclosure, there is provided a gimbal including a shaft assembly and one or more processors electrically coupled to the shaft assembly and individually or collectively configured to calculate a difference between a joint angle of the gimbal at a first position and a joint angle of the gimbal at a second position in response to the gimbal passively rotating from the first position to the second position along a passive rotation direction, control the gimbal to return to the first position from the second position by rotating along a direction opposite to the passive rotation direction in response to the difference satisfying a first condition, and control the gimbal to return to the first position from the second position by rotating along a shortest path or along the direction opposite to the passive rotation direction according to a target sub-region in which the first position is located in response to the difference satisfying a second condition. A rotation region of the gimbal has a joint angle range larger than 360 degrees, and the target sub-region is one of a plurality of sub-regions of the rotation region.

### BRIEF DESCRIPTION OF THE DRAWINGS

In order to provide a clearer illustration of technical solutions of disclosed embodiments, the drawings used in the description of the disclosed embodiments are briefly described below. It will be appreciated that the disclosed drawings are merely examples and other drawings conceived by those having ordinary skills in the art on the basis of the described drawings without inventive efforts should fall within the scope of the present disclosure.

FIG. 1 schematically shows an angle range of a joint angle of a gimbal for a forward rotation region consistent with embodiments of the disclosure.

FIG. 2 schematically shows an angle range of a joint angle of a gimbal for a backward rotation region consistent with embodiments of the disclosure.

FIG. 3 is a schematic flow chart of a method for controlling reset of a gimbal consistent with embodiments of the disclosure.

FIG. 4 schematically shows division of a rotation region of a gimbal consistent with embodiments of the disclosure.

FIG. 5A schematically shows a movement path of a gimbal in a rotation region showing reset of the gimbal when a first position is in region 1 consistent with embodiments of the disclosure.

FIG. 5B schematically shows a movement path of a gimbal in a rotation region showing reset of the gimbal when a first position is in region 2 consistent with embodiments of the disclosure.

FIG. 5C schematically shows a movement path of a gimbal in a rotation region showing reset of the gimbal when a first position is in region 3 consistent with embodiments of the disclosure.

FIG. 5D schematically shows a movement path of a gimbal in a rotation region showing reset of the gimbal when a first position is in region 4 consistent with embodiments of the disclosure.

FIG. 6 schematically shows another division of a rotation region of a gimbal consistent with embodiments of the disclosure.

FIG. 7A schematically shows a movement path of a gimbal in a rotation region showing reset of the gimbal when a first position is in region 5 consistent with embodiments of the disclosure.

FIG. 7B schematically shows a movement path of a gimbal in a rotation region showing reset of the gimbal when a first position is in region 6 consistent with embodiments of the disclosure.

FIG. 8 is a structural block diagram of a device for controlling reset of gimbal consistent with embodiments of the disclosure.

FIG. 9 is a structural block diagram of a gimbal consistent with embodiments of the disclosure.

FIG. 10 is a structural block diagram of an unmanned aerial vehicle (UAV) consistent with embodiments of the disclosure.

FIG. 11 is a schematic structural diagram of a UAV consistent with embodiments of the disclosure.

### DETAILED DESCRIPTION OF THE EMBODIMENTS

In order to provide a clearer illustration of technical solutions of disclosed embodiments, example embodiments will be described with reference to the accompanying drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

A method and device for controlling reset of gimbal, a gimbal, and an unmanned aerial vehicle (UAV) consistent with the present disclosure will be described with reference to the accompanying drawings. Unless conflicting, the exemplary embodiments and features in the exemplary embodiments can be combined with each other.

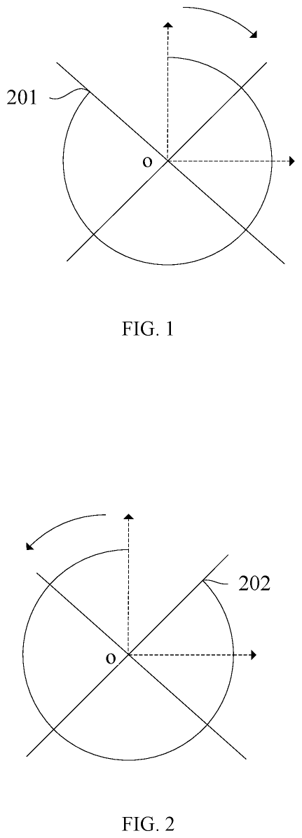

Consistent with the disclosure, a joint angle of the gimbal for a rotation region of the gimbal can be greater than 360 degrees, i.e., the gimbal can rotate more than 360 degrees in the rotation region of the gimbal, i.e., a range of the joint angle, also referred to as a joint angle range, can be more than 360 degrees. In this disclosure, a “region” can refer to, e.g., an angular region between two lines (half lines or line segments) each with a rotation center (e.g., rotation center of the gimbal) as an end thereof. FIG. 1 schematically shows an angle range of the joint angle of the gimbal for a forward rotation region consistent with the disclosure. FIG. 2 schematically shows an angle range of the joint angle of the gimbal for a backward rotation region consistent with the disclosure. The joint angle for the forward rotation region is also referred to as a “forward joint angle” and the joint angle for the backward rotation region is also referred to as a “backward joint angle.” As shown in FIGS. 1 and 2, the rotation region of the gimbal includes the forward rotation region and the backward rotation region. The joint angle of the gimbal for the forward rotation region and the joint angle of the gimbal for the backward rotation region can be both greater than 180 degrees and less than 360 degrees. For example, in some embodiments, the joint angle of the gimbal for the forward rotation region can be 0 to 320 degrees, and the joint angle of the gimbal for the backward rotation region can be 0 to negative 320 degrees. In some embodiments, the joint angle of the gimbal for the forward rotation region can be 0 to 340 degrees, and the joint angle of the gimbal for the backward rotation region can be 0 to negative 320 degrees. A maximum joint angle of the gimbal for the forward rotation region, also referred to as a “maximum forward joint angle,” can refer to a rotation angle of the gimbal when the gimbal rotates from a zero position to a maximum limit position of the forward rotation region (as indicated by 201 in FIG. 1) along a forward rotation direction (as indicated by a curved arrow in FIG. 1) in the forward rotation region. A maximum joint angle of the gimbal for the backward rotation region, also referred to as a “maximum backward joint angle,” can refer to a rotation angle of the gimbal when the gimbal rotates from a zero position to a maximum limit position of the backward rotation region (as indicated by 202 in FIG. 2) along a backward rotation direction (as indicated by a curved arrow in FIG. 2) in the backward rotation region. In this disclosure, a maximum limit position (of the forward or backward rotation region) is also referred to as a “maximum joint angle position” (of the forward or backward rotation region). Further, the maximum joint angle position for the forward rotation region is also referred to as a “maximum forward joint angle position” and the maximum joint angle position for the backward rotation region is also referred to as a “maximum backward joint angle position.” Correspondingly, the maximum limit position of the forward rotation region and the maximum limit position of the backward rotation region are also referred to as “maximum forward limit position” and “maximum backward limit position,” respectively. A maximum limit position (maximum joint angle position) can refer to, e.g., where a half line indicating the angle of the gimbal when the gimbal is at the maximum joint angle (e.g., the half line in FIG. 1 starting from point o and pointing left upward) intersects a circle centered at point o. Hence, a maximum limit position/maximum joint angle position of the forward or the backward rotation region corresponds to a maximum joint angle of the gimbal for the forward or backward rotation region. A mechanical limit can be arranged at each of the maximum limit position of the forward rotation region and the maximum limit position of the backward rotation region.

In some embodiments, when the gimbal is at the zero position, the gimbal can rotate from the zero position to the maximum limit position of the forward rotation region along the forward rotation direction. When the gimbal is at the zero position, the gimbal can rotate from the zero position to the maximum limit position of the backward rotation region along the backward rotation direction. Under a same coordinate system, the clockwise direction can be defined as the forward rotation direction (as indicated by the curved arrow in FIG. 1) and the counterclockwise direction can be defined as the backward rotation direction (as indicated by the curved arrow in FIG. 2). When the gimbal is in the forward rotation region, the joint angle of the gimbal can be positive, and when the gimbal is in the backward rotation region, the joint angle of the gimbal can be negative.

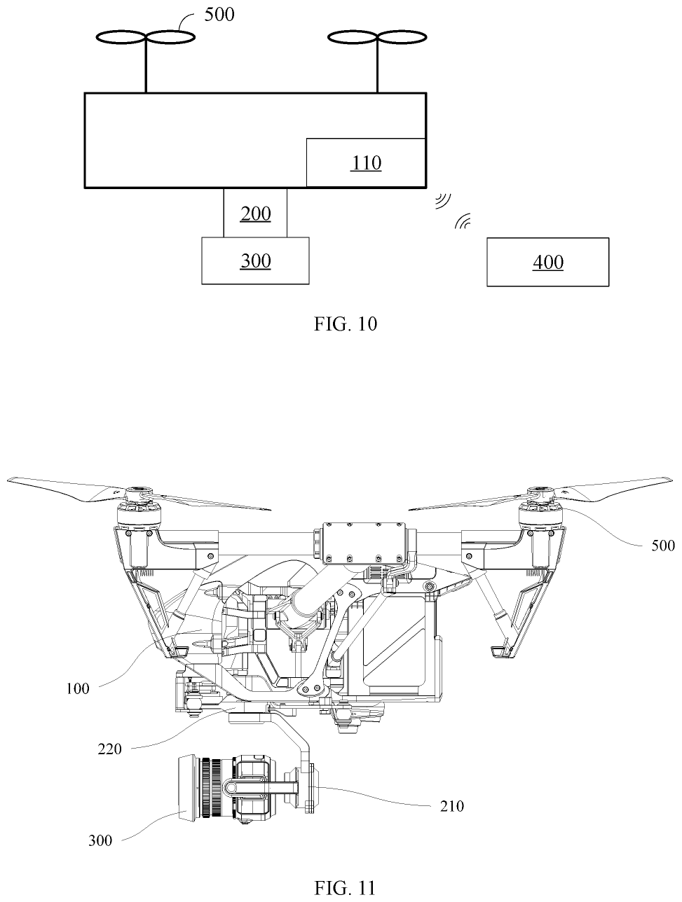

The gimbal may include a two-axis gimbal or a three-axis gimbal. Here, a three-axis gimbal is used as an example for further description. FIG. 9 is a structural block diagram of an example gimbal 200 consistent with the disclosure. FIG. 10 is a structural block diagram showing an example unmanned aerial vehicle (UAV) consistent with the disclosure. FIG. 11 is a schematic structural diagram of another example UAV consistent with the disclosure. As shown in FIGS. 9 to 11, the three-axis gimbal 200 includes a shaft assembly 220, and the shaft assembly 220 may include a yaw axis shaft, a roll axis shaft, and a pitch axis shaft. The shaft assembly 220 may further include a yaw axis motor for controlling a rotation about the yaw axis, a roll axis motor for controlling a rotation about the roll axis, and a pitch axis motor for controlling a rotation about the pitch axis. The yaw axis motor, the roll axis motor, and the pitch axis motor can control the rotation about the yaw axis, the rotation about the roll axis, and the rotation about the pitch axis, respectively, thereby controlling an attitude of the three-axis gimbal 200.

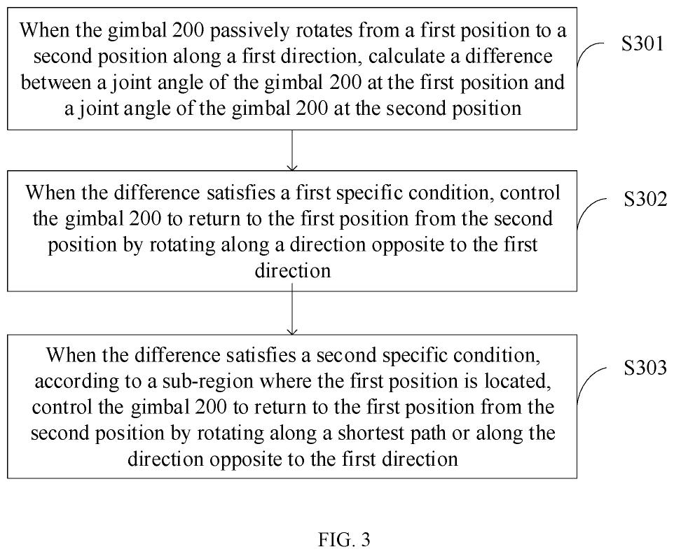

FIG. 3 is a schematic flow chart of an example method for controlling reset of the gimbal consistent with the disclosure. The method may be implemented by, for example, a processor of the gimbal (e.g., the three-axis gimbal 200 in FIGS. 9 to 11), or a flight controller of a UAV having the gimbal (e.g., the UAV in FIGS. 10 and 11).

As shown in FIG. 3, at S301, when the gimbal 200 passively rotates from a first position to a second position along a first direction, a difference between a joint angle of the gimbal 200 at the first position and a joint angle of the gimbal 200 at the second position is calculated.

Passively rotating the gimbal 200 from the first position to the second position along the first direction can refer to that a change of the attitude of the gimbal 200 is not caused by the control of the yaw axis motor, the roll axis motor, and/or the pitch axis motor of the gimbal 200. The first rotation is also referred to as a “passive rotation direction.” The change of the attitude of the gimbal 200 can be monitored in real time by an inertial measurement unit (IMU) arranged at the gimbal 200. After the IMU detects the change of the attitude of the gimbal 200, whether any of the yaw axis motor, the roll axis motor, and the pitch axis motor has received a driving signal sent by a processor 110 of the gimbal 200 or a flight controller of the UAV can be determined. If none of the yaw axis motor, the roll axis motor, and the pitch axis motor have received the driving signal sent by the processor 110 of the gimbal 200 or the flight controller of the UAV, it can be determined that the change of the attitude of the gimbal 200 is realized passively. Passively rotating the gimbal 200 from the first position to the second position along the first direction may include manually rotating, by a user, the gimbal 200 from the first position to the second position along the first direction, or rotating, under other external forces, the gimbal 200 from the first position to the second position along the first direction.

The meaning of the joint angle of the gimbal 200 at the first position will be explained as follows. When the first position is in the forward rotation region, the joint angle of the gimbal 200 at the first position can refer to a rotation angle corresponding to the gimbal 200 rotating from the zero position to the first position along the forward rotation direction, and the joint angle of the gimbal 200 at the first position can have a positive value. When the first position is in the backward rotation region, the joint angle of the gimbal 200 at the first position can refer to a rotation angle corresponding to the gimbal 200 rotating from the zero position to the first position along the backward rotation direction, and the joint angle of the gimbal 200 at the first position can have a negative value. The meaning of the joint angle of the gimbal 200 at the second position is similar to the meaning of the joint angle of the gimbal 200 at the first position, and detailed description thereof is omitted herein.

At S302, when the difference satisfies a first specific condition, the gimbal 200 is controlled to return to the first position from the second position by rotating along a direction opposite to the first direction. This is also referred to as a “first reset strategy.”

In some embodiments, the first specific condition can include that an absolute value of the difference is less than or equal to 180 degrees. For example, when the absolute value of the difference is 30 degrees, 45 degrees, 90 degrees, 120 degrees, 180 degrees, or the like, the gimbal 200 can be automatically controlled to return from the second position to the first position by rotating along the direction opposite to the first direction. The gimbal 200 can be reset successfully without requiring the user to manually reset the gimbal 200. If the gimbal 200 needs to rotate at a larger angle along the first direction to return to the first position from the second position, and the gimbal may collide with the mechanical limit at the forward rotation region or the mechanical limit at the backward rotation region. As a result, the gimbal 200 cannot be reset successfully, and the user needs to manually control the reset of the gimbal 200, thereby resulting in a poor user experience. Moreover, the gimbal 200 may be worn by frequently colliding with the mechanical limits.

When the absolute value of the difference is less than or equal to 180 degrees, the process at S302 can be executed. The process at S302 can be equivalent to controlling the gimbal 200 to return from the second position to the first position by rotating along a shortest path. A magnitude and direction of the joint angle of the gimbal 200 at the first position after the execution of the process at S302 can be the same as those of the joint angle of the gimbal 200 at the first position before the execution of the process at S301.

The joint angle may include a yaw axis angle of the gimbal 200, a roll axis angle of the gimbal 200, or a pitch axis angle of the gimbal 200.

At S303, when the difference satisfies a second specific condition, according to a sub-region where the first position is located, the gimbal 200 is controlled to return to the first position from the second position by rotating along the shortest path or along the direction opposite to the first direction. This is also referred to as a “second reset strategy.” In this disclosure, this sub-region where the first position is located is also referred to as a “target sub-region.”

Controlling the gimbal 200 to return to the first position from the second position by rotating along the shortest path or along the direction opposite can be automatically realized by controlling the yaw axis motor, the roll axis motor, and/or the pitch axis motor of the gimbal 200 by the processor 110 of the gimbal 200 or by the flight controller of the UAV. For example, when the yaw axis of the gimbal 200 is passively rotated from the first position to the second position, the yaw axis motor can be controlled by the processor 110 of the gimbal 200 to return to the first position from the second position by rotating along the shortest path or along the direction opposite to the first direction, or the yaw axis motor can be controlled by the flight controller of the UAV to return to the first position from the second position by rotating along the shortest path or along the direction opposite to the first direction.

In some embodiments, the second specific condition can include that the absolute value of the difference is greater than 180 degrees.

Consistent with the disclosure, when the gimbal 200 is passively triggered at an angle that cannot rotate 360 degrees to rotate from the first position to the second position, an automatic reset manner of the gimbal 200 can be selected according to the difference between the joint angle of the gimbal 200 at the first position and the joint angle of the gimbal 200 at the second position. The issue of the gimbal 200 colliding with the mechanical limits due to the shortest path problem can be avoided, such that a user confusion can be reduced and the user experience can be better.

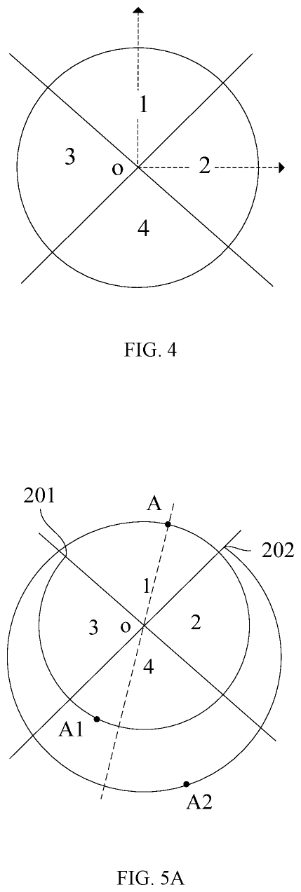

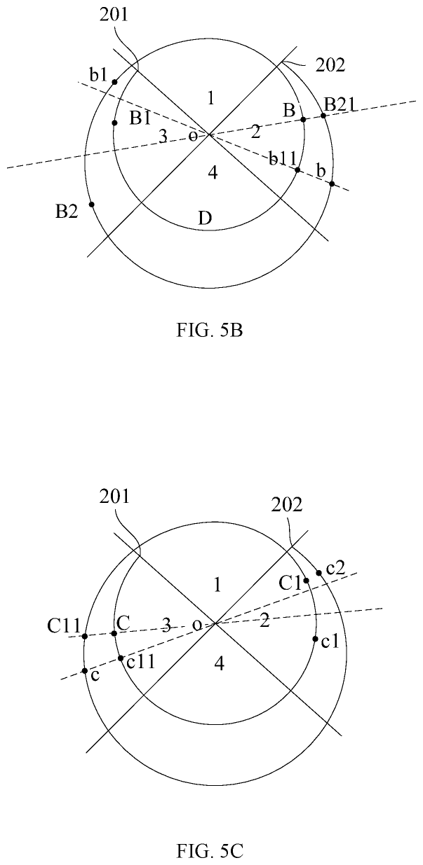

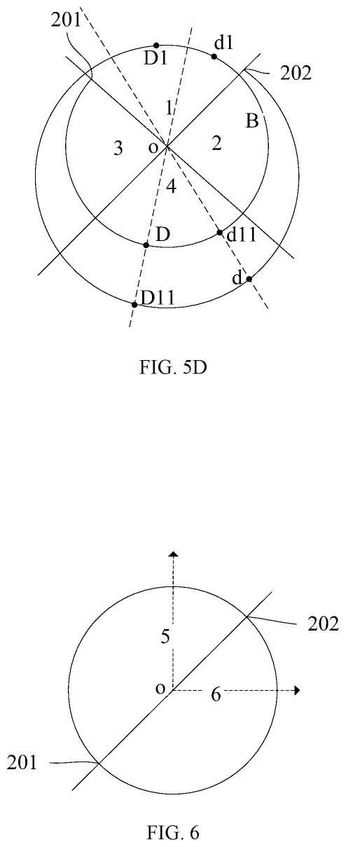

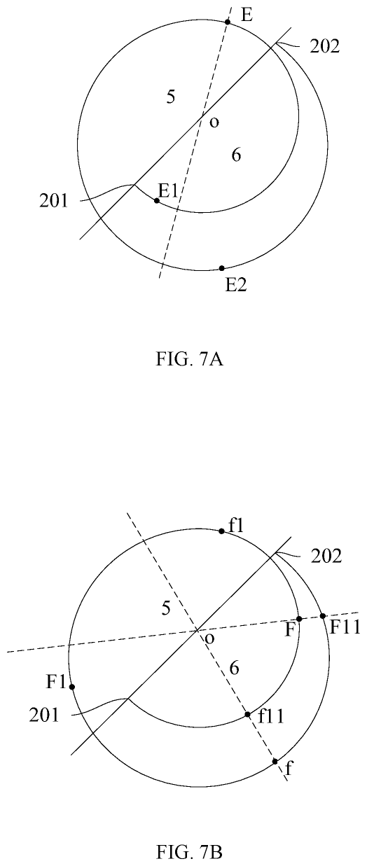

FIG. 4 schematically shows an example division of the rotation region of the gimbal 200 consistent with the disclosure. FIG. 5A schematically shows an example movement path of the gimbal 200 in the rotation region showing the reset of the gimbal 200 when the first position is in region 1 consistent with the disclosure. FIG. 5B schematically shows an example movement path of the gimbal 200 in the rotation region showing the reset of the gimbal 200 when the first position is in region 2 consistent with the disclosure. FIG. 5C schematically shows an example movement path of the gimbal 200 in the rotation region showing the reset of the gimbal 200 when the first position is in region 3 consistent with the disclosure. FIG. 5D schematically shows an example movement path of the gimbal 200 in the rotation region showing the reset of the gimbal 200 when the first position is in region 4 consistent with the disclosure. FIG. 6 schematically shows another example division of the rotation region of the gimbal 200 consistent with the disclosure. FIG. 7A schematically shows an example movement path of the gimbal 200 in the rotation region showing the reset of the gimbal 200 when the first position is in region 5 consistent with the disclosure. FIG. 7B schematically shows an example movement path of the gimbal 200 in the rotation region showing the reset of the gimbal 200 when the first position is in region 6 consistent with the disclosure.

In some embodiments, the rotation region can be divided into a plurality of sub-regions according to a preset rule. For example, the rotation region can be divided into the plurality of sub-regions according to an equal division principle. As another example, the rotation region can be divided into the plurality of the sub-regions according to the maximum joint angle position 201 of the forward rotation region, the maximum joint angle position 202 of the backward rotation region, and a rotation center of the gimbal 200 (represented by 0 in FIGS. 1, 2, and 4 to 7B).

Dividing the rotation region into the plurality of the sub-regions according to the maximum joint angle position 201 of the forward rotation region, the maximum joint angle position 202 of the backward rotation region, and the rotation center of the gimbal 200 is taken as an example to further describe the method for controlling reset of the gimbal 200.

Dividing the rotation region into the plurality of the sub-regions according to the maximum joint angle position 201 of the forward rotation region, the maximum joint angle position 202 of the backward rotation region, and the rotation center of the gimbal 200 can include two situations, e.g., the maximum joint angle position 201 of the forward rotation region, the maximum joint angle position 202 of the backward rotation region, and the rotation center of the gimbal 200 being not collinear, and the maximum joint angle position 201 of the forward rotation region, the maximum joint angle position 202 of the backward rotation region, and the rotation center of the gimbal 200 being collinear.

When the maximum joint angle position 201 of the forward rotation region, the maximum joint angle position 202 of the backward rotation region, and the rotation center of the gimbal 200 are not collinear, as shown in FIGS. 4 and 5A to 5D, a line connecting the maximum joint angle position 201 of the forward rotation region and the rotation center and an extension of the line are used as a first division line, and a line connecting the maximum joint angle position 202 of the backward rotation region and the rotation center and an extension of the line are used as a second division line. The rotation region can be divided into four sub-regions, i.e., region 1, region 2, region 3 and region 4. Region 1 is a sub-region between the line connecting the maximum joint angle position 201 of the forward rotation region and the rotation center and the line connecting the maximum joint angle position 202 of the backward rotation region and the rotation center. Region 2 is a sub-region between the extension of the line connecting the maximum joint angle position 201 of the forward rotation region and the rotation center and the line connecting the maximum joint angle position 202 of the backward rotation region and the rotation center. Region 3 is a sub-region between of the line connecting the maximum joint angle position 201 of the forward rotation region and the rotation center and the extension of the line connecting the maximum joint angle position 202 of the backward rotation region and the rotation center. Region 4 is a sub-region between the extension of the line connecting the maximum joint angle position 201 of the forward rotation region and the rotation center and the extension of the line connecting the maximum joint angle position 202 of the backward rotation region and the rotation center.

When the sub-region where the first position is located is region 1, the process at S303 may include controlling the gimbal 200 to return to the first position from the second position by rotating along the direction opposite to the first direction. Position A in region 1 as shown in

FIG. 5A is taken as an example of the first position for further description. For example, assume that the second position is position A1. When the gimbal 200 passively rotates from position A along the forward rotation direction to position A1 (the absolute value of the difference is greater than 180 degrees), the gimbal 200 can be controlled to return to A from A1 by rotating along the backward rotation direction. However, if the gimbal 200 is reset by rotating along the shortest path, i.e., rotating from A1 along the forward rotation direction, then due to the mechanical limit at the maximum joint angle position 201 in the forward rotation region, the gimbal 200 may collide with the mechanical limit and cannot be reset. As another example, assume that the second position is position A2. When the gimbal 200 passively rotates from A to A2 along the backward rotation direction (the absolute value of the difference is greater than 180 degrees), the gimbal 200 can be controlled to return to A from A2 by rotating along the forward rotation direction. However, if the gimbal 200 is reset by rotating along the shortest path, i.e., rotating from A2 along the backward rotation direction, then due to the mechanical limit at the maximum joint angle position 202 in the backward rotation region, the gimbal 200 may collide with the mechanical limit and cannot be reset.

When the sub-region where the first position is located is region 2, the joint angle of the gimbal 200 at the first position can have a positive value or a negative value. When the joint angle of the gimbal 200 at the first position has the positive value, the process at S303 may include, if the first direction is the forward rotation direction, controlling the gimbal 200 to return to the first position from the second position by rotating along the backward rotation direction, and if the first direction is the backward rotation direction, controlling the gimbal 200 to return to the first position from the second position by rotating along the shortest path. Position B in region 2 as shown in FIG. 5B is taken as an example of the first position for further description. For example, assume that the second position is position B1. When the gimbal 200 passively rotates from position B to position B1 along the forward rotation direction (the absolute value of the difference is greater than 180 degrees), the gimbal 200 can be controlled to return to B from B1 by rotating along the backward rotation direction. However, if the gimbal 200 is reset by rotating along the shortest path, i.e., rotating from B1 along the forward rotation direction, then due to the mechanical limit at the maximum joint angle position 201 in the forward rotation region, the gimbal 200 may collide with the mechanical limit and cannot be reset. As another example, the second position is position B2. When the gimbal 200 passively rotates from position B to position B2 along the backward rotation direction (the absolute value of the difference is greater than 180 degrees), since the gimbal 200 can continue to rotate 360 degrees along the backward rotation direction at B, the gimbal 200 can be controlled to return to B from B2 by rotating along the backward rotation direction (i.e., the gimbal 200 can be reset by rotating along the shortest path from B2). At this time, the gimbal 200 can be located at B21. The magnitude of the joint angle of the gimbal 200 at B21 can be equal to that of the joint angle of the gimbal 200 at B, and the direction of the joint angle of the gimbal 200 at B21 can be opposite to that of the joint angle of the gimbal 200 at B.

When the joint angle of the gimbal 200 at the first position has the negative value, the process at S303 may include, if the first direction is the forward rotation direction, controlling the gimbal 200 to return to the first position from the second position by rotating along the shortest path. Position b in region 2 as shown in FIG. 5B is taken as an example of the first position for further description. For example, assume that the second position is position b1. When the gimbal 200 passively rotates from b to position b1 along the forward rotation direction (the absolute value of the difference is greater than 180 degrees), the gimbal 200 can be controlled to return to b from b1 by rotating along the forward rotation direction (i.e., the gimbal 200 can be reset by rotating along the shortest path at b1). Since the gimbal 200 can rotate 360 degrees along the forward rotation direction at b, the gimbal 200 can be controlled to return to b from b1 by rotating along the forward rotation direction, and then, the gimbal 200 can be located at b11. The magnitude of the joint angle of the gimbal 200 at b11 can be equal to that of the joint angle of the gimbal 200 at b, and the direction of the joint angle of the gimbal 200 at b11 can be opposite to that of the joint angle of the gimbal 200 at b. When the gimbal 200 passively rotates from b along the backward rotation direction, due to a limitation of the mechanical limit at the maximum joint angle 202 in the backward rotation region, the rotation of the gimbal 200 cannot exceed 180 degrees, and the process at S302 can be implemented.

When the sub-region where the first position is located is region 3, the joint angle of the gimbal 200 at the first position can have a positive value or a negative value. When the joint angle of the gimbal 200 at the first position has the positive value, the process at S303 may include, if the first direction is the backward rotation direction, controlling the gimbal 200 to return to the first position from the second position by rotating along the shortest path. Position C in region 3 as shown in FIG. 5C is taken as an example of the first position for further description. For example, assume that the second position is position C1. When the gimbal 200 passively rotates from C along the backward rotation direction to position C1 (the absolute value of the difference is greater than 180 degrees), since the gimbal 200 can rotate 360 degrees along the backward rotation direction at C, the gimbal 200 can be controlled to return to C from C1 by rotating along the backward rotation direction (i.e., the gimbal 200 can be reset by rotating along the shortest path at C1), and then the gimbal 200 can be located at C11. The magnitude of the joint angle of the gimbal 200 at C11 can be equal to that the joint angle of the gimbal 200 at C, and the direction of the joint angle of the gimbal 200 at C11 can be opposite to that of the joint angle of the gimbal 200 at C. When the gimbal 200 passively rotates from C1 along the forward rotation direction, the rotation of the gimbal 200 cannot exceed 180 degrees due to the mechanical limit at the maximum joint angle 201 of the forward rotation region, and the process at S302 can be implemented.

When the joint angle of the gimbal 200 at the first position has the negative value, the process at S303 may include, if the first direction is the forward rotation direction, controlling the gimbal 200 to return to the first position from the second position by rotating along the shortest path, and if the first direction is the backward rotation direction, controlling the gimbal 200 to return to the first position from the second position by rotating along the forward rotation direction. Position c in region 3 as shown in FIG. 5C as an example of the first position for further description. For example, assume that the second position is position c1. When the gimbal 200 passively rotates from c along the forward rotation direction to c1 (the absolute value of the difference is greater than 180 degrees), since the gimbal 200 can rotate 360 degrees in the forward rotation direction at c, the gimbal 200 can be controlled to return to c from c1 by rotating along the forward rotation direction (i.e., the gimbal 200 can be reset by rotating along the shortest path at c1), and then, the gimbal 200 can be located at c11. The magnitude of the joint angle of the gimbal 200 at c11 can be equal to that of the joint angle of the gimbal 200 at c, and the direction of the joint angle of the gimbal 200 at c11 can be opposite to that of the joint angle of the gimbal 200 at c. As another example, assume the second position is position c2. When the gimbal 200 passively rotates from c along the backward rotation direction to c2 (the absolute value of the difference is greater than 180 degrees), the gimbal 200 can be controlled to return to c from c2 by rotating along the forward rotation direction. If the gimbal 200 is reset by rotating along the shortest path, i.e., rotating from c2 along the backward rotation direction, however, due to the mechanical limit at the maximum joint angle position 202 in the backward rotation region, the gimbal 200 may collide with the mechanical limit and cannot be reset.

When the sub-region where the first position is located is region 4, the joint angle of the gimbal 200 at the first position can have a positive value or a negative value. In some embodiments, the process at S303 can include controlling the gimbal 200 to return to the first position from the second position by rotating along the shortest path. When the joint angle of the gimbal 200 at the first position has the positive value, position D in region 4 as shown in FIG. 5D is taken as an example of the first position for further description. When the gimbal 200 passively rotates along the forward rotation direction from D, due to the mechanical limit at the maximum joint angle 201 in the forward rotation region, the rotation of the gimbal 200 cannot exceed 180 degrees, and the process at S302 can be implemented. For example, assume that the second position is position D1. When the gimbal 200 passively rotates from D along the backward rotation direction to position D1 (the absolute value of the difference is greater than 180 degrees), since the gimbal 200 can rotate 360 degrees along the backward rotation direction at D, the gimbal 200 can be controlled to return to D from D1 by rotating along the backward rotation direction (i.e., the gimbal 200 can be reset by rotating along the shortest path at D1), and then, the gimbal 200 can be located at D11. The magnitude of the joint angle of the gimbal 200 at D11 can be equal to that of the joint angle of the gimbal 200 at D, and the direction of the joint angle of the gimbal 200 at D11 can be opposite to that of the joint angle of the gimbal 200 at D.

When the joint angle of the gimbal 200 at the first position has the negative value, position d in region 4 as shown in FIG. 5D is taken as an example of the first position for further description. For example, assume that the second position is position d1. When the gimbal 200 passively rotates from d along the forward rotation direction to position d1 (the absolute value of the difference is greater than 180 degrees), since the gimbal 200 can rotate 360 degrees along the backward rotation direction at d, the gimbal 200 can be controlled to return to d from d1 by rotating along the backward rotation direction (i.e., the gimbal 200 can be reset by rotating along the shortest path at d1), and then, the gimbal 200 can be located at d11. The magnitude of the joint angle of the gimbal 200 at d11 can be equal to that of the joint angle of the gimbal 200 at d, and the direction of the joint angle of the gimbal 200 at d11 can be opposite to that of the joint angle of the gimbal 200 at d. When the gimbal 200 rotates passively along the backward rotation direction from d, the rotation of the gimbal 200 cannot exceed 180 degrees due to the mechanical limit at the maximum joint angle 202 of the backward rotation region and the process at S302 can be implemented.

When the maximum joint angle position 201 of the forward rotation region, the maximum joint angle position 202 of the backward rotation region, and the rotation center of the gimbal 200 are collinear, as shown in FIGS. 6, 7A, and 7B, a line connecting the maximum joint angle position 201 of the forward rotation region and the maximum joint angle position 202 of the backward rotation region is used as a division line. The rotation region can be divided into two sub-regions by the division line, i.e., region 5 and region 6. Region 5 can include a portion where the forward rotation region and the backward rotation region do not overlap. Region 6 can include a portion where the forward rotation region and the backward rotation region overlap.

When the sub-region where the first position is located is region 5, the process at S303 may include controlling the gimbal 200 to return to the first position from the second position by rotating along the direction opposite to the first direction. Position E in region 5 as shown in FIG. 7A is taken as an example of the first position for further description. For example, assume that the second position is position E1. When the gimbal 200 passively rotates from position E along the forward rotation direction to position E1 (the absolute value of the difference is greater than 180 degrees), the gimbal 200 can be controlled to return to E from the E1 by rotating along the backward rotation direction. However, if the gimbal 200 is reset by rotating along the shortest path, i.e., rotating along the forward rotation direction from E1, then due to the mechanical limit at the maximum joint angle position 201 in the forward rotation region, the gimbal 200 may collide with the mechanical limit and cannot be reset. As another example, assume that the second position is position E2. When the gimbal 200 passively rotates from E along the backward direction to E2 (the absolute value of the difference is greater than 180 degrees), the gimbal 200 can be controlled to return to E from E1 by rotating along the forward rotation direction. However if the gimbal 200 is reset by rotating along the shortest path, i.e., rotating from E1 along the backward rotation direction, then due to the mechanical limit at the maximum joint angle position 202 in the backward rotation region, the gimbal 200 may collide with the mechanical limit and cannot be reset.

When the sub-region where the first position is located is region 6, the process at S303 may include controlling the gimbal 200 to return to the first position from the second position by rotating along the shortest path. The joint angle of the gimbal 200 at the first position can have a positive value or a negative value.

When the joint angle of the gimbal 200 at the first position has the positive value, position F in region 6 as shown in FIG. 7B is taken as an example of the first position for further description. For example, assume that the second position is position F1. When the gimbal 200 passively rotates from F along the backward rotation direction to position F1 (the absolute value of the difference is greater than 180 degrees), the gimbal 200 can rotate 360 degrees along the backward rotation direction at F, the gimbal 200 can be controlled to return to F from F1 by rotating along the backward rotation direction (i.e., the gimbal 200 can be reset by rotating along the shortest path at F1), and then, the gimbal 200 can be located at F11. The magnitude of the joint angle of the gimbal 200 at F11 can be equal to that of the joint angle of the gimbal 200 at F, and the direction of the joint angle of the gimbal 200 at F11 can be opposite to that of the joint angle of the gimbal 200 at F. When the gimbal 200 passively rotates from F along the forward rotation direction, due to the limitation of the mechanical limit at the maximum joint angle 201 in the forward rotation region, the rotation of the gimbal 200 cannot exceed 180 degrees, and the process at S302 can be implemented.

When the joint angle of the gimbal 200 at the first position has the negative value, position fin region 6 as shown in FIG. 7B is taken as an example of the first position for further description. For example, assume that the second position is position f1. When the gimbal 200 passively rotates from f along the backward rotation direction to position f1 (the absolute value of the difference is greater than 180 degrees), the gimbal 200 can rotate 360 degrees along the backward rotation direction at f, the gimbal 200 can be controlled to return to f from f1 by rotating along the backward rotation direction (i.e., the gimbal 200 can be reset by rotating along the shortest path at f1), and then, the gimbal 200 can be located at f11. The magnitude of the joint angle of the gimbal 200 at f11 can be equal to that of the joint angle of the gimbal 200 at f, and the direction of the joint angle of the gimbal 200 at f11 can be opposite to that of the joint angle of the gimbal 200 at f. When the gimbal 200 passively rotates from f along the forward rotation direction, due to the limitation of the mechanical limit at the maximum joint angle 201 in the forward rotation region, the rotation of the gimbal 200 cannot exceed 180 degrees, and the process at S302 can be implemented.

After the gimbal 200 is controlled to return to the first position from the second position by rotating along the shortest path at S303, the direction of the joint angle of the gimbal 200 at the first position can be opposite from that of the gimbal 200 before passively rotating the gimbal 200 from the first position to the second position by rotating along the first direction, which is similar to the embodiments described above and detailed description thereof is omitted herein.

In some embodiments, controlling the gimbal 200 to return to the first position from the second position by rotating along the direction opposite to the first direction may include: controlling the gimbal 200 to return to the first position from the second position by rotating along the direction opposite to the first direction at a first preset speed. The first preset speed can be greater than 0°/s and less than 180°/s. The gimbal 200 can be smoothly reset from the second position to the first position by setting the speed at which the gimbal 200 is reset.

In some embodiments, controlling the gimbal 200 to return to the first position by rotating along the shortest path may include: controlling the gimbal 200 to return to the first position by rotating along the shortest path at a second preset speed. The second preset speed can be greater than 0°/s and less than 180°/s. The gimbal 200 can be smoothly reset from the second position to the first position by setting the speed at which the gimbal 200 is reset. The second preset speed may be equal or not equal to the first preset speed, which can be selected according to needs.

Determining the sub-region where the first position is located may include: determining an attitude of a gimbal base 220 (shown in FIG. 11) and the attitude of the gimbal 200 at the first position, and determining the sub-region where the first position is located according to the attitude of the gimbal base 220 and the attitude of the gimbal 200 at the first position. In practical applications, since the gimbal 200 is fixedly connected to the gimbal base 220, a change of the attitude of the gimbal base 220 can cause a change of the attitude of the gimbal 200, and hence, the attitude of the gimbal 200 needs to be calculated according to both the attitude of the gimbal base 220 and the attitude of the gimbal 200 at the first position. After the rotation region is divided into the plurality of sub-regions, each sub-region can correspond to an attitude range. According to the calculated attitude of the gimbal 200 and the attitude range corresponding to each sub-region, the sub-region where the gimbal 200 is currently located can be determined.

Obtaining the attitude of the gimbal base 200 may include the following processes. In some embodiments, when the gimbal 200 is mounted at the UAV via the gimbal base 220, determining the attitude of the gimbal base 220 may include: obtaining a real-time attitude of the UAV at which the gimbal 200 is mounted, and determining the attitude of the gimbal base 220 according to the real-time attitude of the UAV. In some embodiments, the attitude of the gimbal base 220 can be the same as the real-time attitude of the UAV. In some other embodiments, there may be a fixed transformation relationship between the attitude of the gimbal base 220 and the real-time attitude of the UAV. The real-time attitude of the UAV can be directly monitored by an attitude sensor mounted at a body of the UAV.

In some embodiments, the attitude of the gimbal 200 can be obtained by a detection of an attitude sensor arranged at the gimbal 200. The attitude of the gimbal 200 at the first position can be directly obtained according to the detection of the attitude sensor arranged at the gimbal 200.

In some embodiments, determining the sub-region where the first position is located according to the attitude of the gimbal base 220 and the attitude of the gimbal 200 at the first position may include: determining a rotational attitude of the gimbal base 220 at the first position according to the attitude of the gimbal base 220 and the attitude of the gimbal 200 at the first position, calculating the joint angle of the gimbal 200 at the first position (i.e., the angle that the gimbal 200 has rotated relative to the gimbal base 220) according to the rotational attitude, and determining the sub-region where the first position is located according to the joint angle of the gimbal 200 at the first position and the plurality of sub-regions. After the rotation region is divided into the plurality of sub-regions, each sub-region corresponding to a joint angel range. According to the calculated joint angle of the gimbal 200 at the first position and the joint angle range corresponding to each sub-region, the sub-region where the gimbal 200 is currently located can be determined.

Herein, the attitude can be represented by quaternion or Euler angle, and the quaternion and Euler angle can be converted to each other using a corresponding formula.

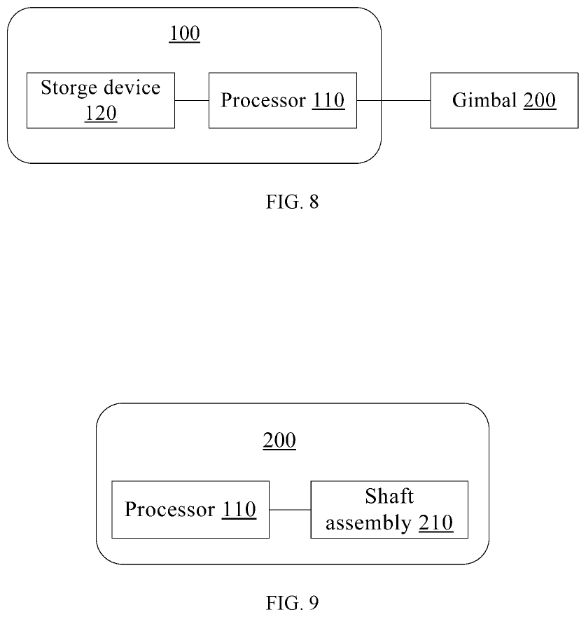

FIG. 8 is a structural block diagram of a device 100 for controlling reset of gimbal consistent with embodiments of the disclosure. As shown in FIG. 8, the device 100 includes a processor 110 (e.g., a single-core or multi-core processor), and the processor 110 can be electrically coupled to the gimbal 200. The joint angle of the gimbal 200 for the rotation region of the gimbal 200 can be greater than 360 degrees, and the rotation region can be divided into the plurality of sub-regions according to the preset rule.

The processor 110 may include a central processing unit (CPU). The processor 110 may further include a hardware chip. The hardware chip may include an application-specific integrated circuit (ASIC), a programmable logic device (PLD), or any combination thereof. The PLD may include a complex programmable logic device (CPLD), a field-programmable gate array (FPGA), a general array logic (GAL), or any combination thereof.

In some embodiments, the device 100 can include one or more processors 110 working individually or collectively.

In some embodiments, the processor 110 can be configured, when the gimbal 200 passively rotates from the first position to the second position along the first direction, to calculate the difference between the joint angle of the gimbal 200 at the first position and the joint angle of the gimbal 200 at the second position, when the difference satisfies the first specific condition, to control the gimbal 200 to return to the first position from the second position by rotating along the direction opposite to the first direction, when the difference satisfies the second specific condition, according to the sub-region where the first position is located, to control the gimbal 200 to return to the first position from the second position by rotating along the shortest path or along the direction opposite to the first direction.

Consistent with the disclosure, when the gimbal 200 is passively triggered at the angle that cannot rotate 360 degrees to rotate from the first position to the second position, the automatic reset manner of the gimbal 200 can be selected according to the difference between the joint angle of the gimbal 200 at the first position and the joint angle of the gimbal 200 at the second position. The issue of the gimbal 200 colliding with the mechanical limits due to the shortest path problem can be avoided, such that the user confusion can be reduced and the user experience can be better.

In some embodiments, the first specific condition can include that the absolute value of the difference is less than or equal to 180 degrees. In some embodiments, the second specific condition can include that the absolute value of the difference is greater than 180 degrees. In some embodiments, the rotation region can be divided into the plurality of sub-regions according to the equal division principle.

In some embodiments, the rotation region of the gimbal can include the forward rotation region and the backward rotation region. The joint angle of the gimbal for the forward rotation region and the joint angle of the gimbal for the backward rotation region can be both greater than 180 degrees and less than 360 degrees. The rotation region can be divided into the plurality of the sub-regions according to the maximum joint angle position 201 of the forward rotation region, the maximum joint angle position 202 of the backward rotation region, and the rotation center of the gimbal 200. In some embodiments, the maximum joint angle position 201 of the forward rotation region, the maximum joint angle position 202 of the backward rotation region, and the rotation center of the gimbal 200 can be not collinear.

In some embodiments, the sub-region where the first position is located can be the sub-region between the line connecting the maximum joint angle position 201 of the forward rotation region and the rotation center and the line connecting the maximum joint angle position 202 of the backward rotation region and the rotation center, and the processor 110 can be configured to control the gimbal 200 to return to the first position from the second position by rotating along the direction opposite to the first direction.

In some embodiments, the sub-region where the first position is located can be the sub-region between the extension of the line connecting the maximum joint angle position 201 of the forward rotation region and the rotation center and the line connecting the maximum joint angle position 202 of the backward rotation region and the rotation center. When the joint angle of the gimbal 200 at the first position has the positive value, the processor 110 can be configured, if the first direction is the forward rotation direction, to control the gimbal 200 to return to the first position from the second position by rotating along the backward rotation direction, and if the first direction is the backward rotation direction, to control the gimbal 200 to return to the first position from the second position by rotating along the shortest path. When the joint angle of the gimbal 200 at the first position has the negative value, the processor 110 can be configured, if the first direction is the forward rotation direction, to control the gimbal 200 to return to the first position from the second position by rotating along the shortest path.

In some embodiments, the sub-region where the first position is located can be the sub-region between of the line connecting the maximum joint angle position 201 of the forward rotation region and the rotation center and the extension of the line connecting the maximum joint angle position 202 of the backward rotation region and the rotation center. When the joint angle of the gimbal 200 at the first position has the positive value, the processor 110 can be configured, if the first direction is the backward rotation direction, to control the gimbal 200 to return to the first position from the second position by rotating along the shortest path. When the joint angle of the gimbal 200 at the first position has the negative value, the processor 110 can be configured, if the first direction is the forward rotation direction, to control the gimbal 200 to return to the first position from the second position by rotating along the shortest path, and if the first direction is the backward rotation direction, to control the gimbal 200 to return to the first position from the second position by rotating along the forward rotation direction.

In some embodiments, the sub-region where the first position is located can be the sub-region between the extension of the line connecting the maximum joint angle position 201 of the forward rotation region and the rotation center and the extension of the line connecting the maximum joint angle position 202 of the backward rotation region and the rotation center, and the processor 110 can be configured to control the gimbal 200 to return to the first position from the second position by rotating along the shortest path.

In some embodiments, the maximum joint angle position 201 of the forward rotation region, the maximum joint angle position 202 of the backward rotation region, and the rotation center of the gimbal 200 can be collinear. In some embodiments, the sub-region where the first position is located can be the portion where the forward rotation region and the backward rotation region do not overlap, and the processor 110 can be configured to control the gimbal 200 to return to the first position from the second position by rotating along the direction opposite to the first direction. In some embodiments, the sub-region where the first position is located can be the portion where the forward rotation region and the backward rotation region overlap, and the processor 110 can be configured to control the gimbal 200 to return to the first position from the second position by rotating along the shortest path.

In some embodiments, after the gimbal 200 is controlled to return to the first position from the second position by rotating along the shortest path, the direction of the joint angle of the gimbal 200 at the first position can be opposite from that of the gimbal 200 before passively rotating the gimbal 200 from the first position to the second position by rotating along the first direction.

In some embodiments, the processor 110 can be configured to control the gimbal 200 to return to the first position from the second position by rotating along the direction opposite to the first direction at the first preset speed. The first preset speed can be greater than 0°/s and less than 180°/s.

In some embodiments, the processor 110 can be configured to control the gimbal 200 to return to the first position by rotating along the shortest path at the second preset speed. The second preset speed can be greater than 0°/s and less than 180°/s.

In some embodiments, the processor 110 can be configured to determine the attitude of the gimbal base 220 and the attitude of the gimbal 200 at the first position, and determine the sub-region where the first position is located according to the attitude of the gimbal base 220 and the attitude of the gimbal 200 at the first position.

In some embodiments, the processor 110 can be configured to determine the rotational attitude of the gimbal base 220 at the first position according to the attitude of the gimbal base 220 and the attitude of the gimbal 200 at the first position, calculate the joint angle of the gimbal 200 at the first position according to the rotational attitude, and determine the sub-region where the first position is located according to the joint angle of the gimbal 200 at the first position and the plurality of sub-regions.

In some embodiments, the processor 110 can be configured to obtain the real-time attitude of the UAV at which the gimbal 200 is mounted, and determine the attitude of the gimbal base 220 according to the real-time attitude of the UAV. In some embodiments, the joint angle may include the yaw axis angle of the gimbal 200.

As shown in FIG. 8, the device 100 further includes a storage device 120. The storage device 120 may include a volatile memory, e.g., a random-access memory (RAM), a non-volatile memory, e.g., a flash memory, a hard disk drive (HDD), or a solid-state drive (SSD), or any combination thereof. In some embodiments, the storage device 120 can be configured to store program instructions. The processor 110 can be configured to call the program instructions to implement the method consistent with the disclosure, e.g., the method shown in FIG. 3.

The implementation of the processor 110 is similar to that of the method in FIG. 3, and detailed description can be omitted herein.

Referring again to FIG. 9, the gimbal 200 includes a shaft assembly 210 and the processor 110 (e.g., a single-core or multi-core processor). The processor 110 can be electrically coupled to the shaft assembly 210. The joint angle of the gimbal 200 for the rotation region of the gimbal 200 can be greater than 360 degrees, and the rotation region can be divided into the plurality of sub-regions according to the preset rule.

The processor 110 may include a central processing unit (CPU). The processor 110 may further include a hardware chip. The hardware chip may include an application-specific integrated circuit (ASIC), a programmable logic device (PLD), or any combination thereof. The PLD may include a complex programmable logic device (CPLD), a field-programmable gate array (FPGA), a general array logic (GAL), or any combination thereof.

In some embodiments, the gimbal 200 can include one or more processors 110 working individually or collectively.

In some embodiments, the processor 110 can be configured, when the shaft assembly 210 passively rotates from the first position to the second position along the first direction, to calculate the difference between a joint angle of the shaft assembly 210 at the first position and the joint angle of the shaft assembly 210 at the second position, when the difference satisfies the first specific condition, to control the shaft assembly 210 to return to the first position from the second position by rotating along the direction opposite to the first direction, when the difference satisfies the second specific condition, according to the sub-region where the first position is located, to control the shaft assembly 210 to return to the first position from the second position by rotating along the shortest path or along the direction opposite to the first direction. In some embodiments, the joint angle of the shaft assembly 210 can be the joint angle of the gimbal 200.

Consistent with the disclosure, when the gimbal 200 is passively triggered at the angle that cannot rotate 360 degrees to rotate from the first position to the second position, the automatic reset manner of the gimbal 200 can be selected according to the difference between the joint angle of the gimbal 200 at the first position and the joint angle of the gimbal 200 at the second position. The issue of the gimbal 200 colliding with the mechanical limits due to the shortest path problem can be avoided, such that the user confusion can be reduced and the user experience can be better.

In some embodiments, the first specific condition can include that the absolute value of the difference is less than or equal to 180 degrees. In some embodiments, the second specific condition can include that the absolute value of the difference is greater than 180 degrees. In some embodiments, the rotation region can be divided into the plurality of sub-regions according to the equal division principle.

In some embodiments, the rotation region of the gimbal can include the forward rotation region and the backward rotation region. The joint angle of the gimbal for the forward rotation region and the joint angle of the gimbal for the backward rotation region can be both greater than 180 degrees and less than 360 degrees. The rotation region can be divided into the plurality of the sub-regions according to the maximum joint angle position 201 of the forward rotation region, the maximum joint angle position 202 of the backward rotation region, and the rotation center of the gimbal 200. In some embodiments, the maximum joint angle position 201 of the forward rotation region, the maximum joint angle position 202 of the backward rotation region, and the rotation center can be not collinear.

In some embodiments, the sub-region where the first position is located can be the sub-region between the line connecting the maximum joint angle position 201 of the forward rotation region and the rotation center and the line connecting the maximum joint angle position 202 of the backward rotation region and the rotation center, and the processor 110 can be configured to control the shaft assembly 210 to return to the first position from the second position by rotating along the direction opposite to the first direction.

In some embodiments, the sub-region where the first position is located can be the sub-region between the extension of the line connecting the maximum joint angle position 201 of the forward rotation region and the rotation center and the line connecting the maximum joint angle position 202 of the backward rotation region and the rotation center. When the joint angle of the shaft assembly 210 at the first position has the positive value, the processor 110 can be configured, if the first direction is the forward rotation direction, to control the shaft assembly 210 to return to the first position from the second position by rotating along the backward rotation direction, and if the first direction is the backward rotation direction, to control the shaft assembly 210 to return to the first position from the second position by rotating along the shortest path. When the joint angle of the shaft assembly 210 at the first position has the negative value, the processor 110 can be configured, if the first direction is the forward rotation direction, to control the shaft assembly 210 to return to the first position from the second position by rotating along the shortest path.

In some embodiments, the sub-region where the first position is located can be the sub-region between of the line connecting the maximum joint angle position 201 of the forward rotation region and the rotation center and the extension of the line connecting the maximum joint angle position 202 of the backward rotation region and the rotation center. When the joint angle of the shaft assembly 210 at the first position has the positive value, the processor 110 can be configured, if the first direction is the backward rotation direction, to control the shaft assembly 210 to return to the first position from the second position by rotating along the shortest path. When the joint angle of the shaft assembly 210 at the first position has the negative value, the processor 110 can be configured, if the first direction is the forward rotation direction, to control the shaft assembly 210 to return to the first position from the second position by rotating along the shortest path, and if the first direction is the backward rotation direction, to control the shaft assembly 210 to return to the first position from the second position by rotating along the forward rotation direction.

In some embodiments, the sub-region where the first position is located can be the sub-region between the extension of the line connecting the maximum joint angle position 201 of the forward rotation region and the rotation center and the extension of the line connecting the maximum joint angle position 202 of the backward rotation region and the rotation center, and the processor 110 can be configured to control the shaft assembly 210 to return to the first position from the second position by rotating along the shortest path.

In some embodiments, the maximum joint angle position 201 of the forward rotation region, the maximum joint angle position 202 of the backward rotation region, and the rotation center can be collinear. In some embodiments, the sub-region where the first position is located can be the portion where the forward rotation region and the backward rotation region do not overlap, and the processor 110 can be configured to control the shaft assembly 210 to return to the first position from the second position by rotating along the direction opposite to the first direction. In some embodiments, the sub-region where the first position is located can be the portion where the forward rotation region and the backward rotation region overlap, and the processor 110 can be configured to control the shaft assembly 210 to return to the first position from the second position by rotating along the shortest path.

In some embodiments, after the shaft assembly 210 is controlled to return to the first position from the second position by rotating along the shortest path, the direction of the joint angle of the shaft assembly 210 at the first position can be opposite from that of the shaft assembly 210 before passively rotating the shaft assembly 210 from the first position to the second position by rotating along the first direction.

In some embodiments, the processor 110 can be configured to control the shaft assembly 210 to return to the first position from the second position by rotating along the direction opposite to the first direction at the first preset speed. The first preset speed can be greater than 0°/s and less than 180°/s.

In some embodiments, the processor 110 can be configured to control the shaft assembly 210 to return to the first position by rotating along the shortest path at the second preset speed. The second preset speed can be greater than 0°/s and less than 180°/s.

Referring again to FIG. 11, in some embodiments, the gimbal 200 further includes the gimbal base 220, and the shaft assembly 210 can be at least partially fixedly connected to the gimbal base 220. The processor 110 can be configured to determine the attitude of the gimbal base 220 and an attitude of the shaft assembly 210 at the first position, and determine the sub-region where the first position is located according to the attitude of the gimbal base 220 and the attitude of the shaft assembly 210 at the first position.

In some embodiments, the processor 110 can be configured to determine the rotational attitude of the gimbal base 220 at the first position according to the attitude of the gimbal base 220 and the attitude of the shaft assembly 210 at the first position, calculate the joint angle of the shaft assembly 210 at the first position according to the rotational attitude, and determine the sub-region where the first position is located according to the joint angle of the shaft assembly 210 at the first position and the plurality of sub-regions.

In some embodiments, the processor 110 can be configured to obtain the real-time attitude of the UAV at which the gimbal 200 is mounted, and determine the attitude of the gimbal base 220 according to the real-time attitude of the UAV. In some embodiments, the shaft assembly 210 can include the yaw axis shaft, and the joint angle may include the yaw axis angle of the shaft assembly 210.

The implementation of the processor 110 is similar to that of the method in FIG. 3, and detailed description is omitted here.

In some embodiments, the processor 110 can be the controller of the gimbal 200. In some other embodiments, when the gimbal 200 is carried by the UAV, the processor 110 can be the flight controller of the UAV.

In some embodiments, the gimbal 200 may include a two-axis gimbal or a three-axis gimbal. Herein, a three-axis gimbal is taken as an example of the gimbal 200 for further description. The shaft assembly 220 may include the yaw axis shaft, the roll axis shaft, and the pitch axis shaft. The shaft assembly 220 may further include the yaw axis motor for controlling the rotation about the yaw axis, the roll axis motor for controlling the rotation about the roll axis, and the pitch axis motor for controlling the rotation about the pitch axis. In some embodiments, the processor 110 is a flight controller, and the yaw axis motor, the roll axis motor, and the pitch axis motor can be electrically coupled to the flight controller, such that the flight controller can control the rotation of the yaw axis motor, the rotation of the roll axis motor, and the rotation of the pitch axis motor, thereby controlling the attitude of the three-axis gimbal.

As shown in FIG. 11, the gimbal 200 carries a load 300, and the load 300 may include an image acquisition device or an imaging device (e.g., a camera, a camcorder, an infrared camera device, an ultraviolet camera device, or the like), an audio acquisition device (e.g., parabolic reflector microphone), an infrared camera device, and/or the like. The load 300 may provide static sensing data (e.g., images) or dynamic sensing data (e.g., videos). The load 300 can be mounted at a carrier (e.g., the gimbal 200), such that the carrier can control the load 300 to rotate.

As shown in FIGS. 10 and 11, the present disclosure further provides the UAV. The UAV includes a body, the gimbal 200 mounted at the body, and the processor 110 (e.g., a single-core or multi-core processor). The processor 110 can be electrically coupled to the gimbal 200. The joint angle of the gimbal 200 for the rotation region of the gimbal 200 can be greater than 360 degrees, and the rotation region can be divided into the plurality of sub-regions according to the preset rule.

The processor 110 may include a central processing unit (CPU). The processor 110 may further include a hardware chip. The hardware chip may include an application-specific integrated circuit (ASIC), a programmable logic device (PLD), or any combination thereof. The PLD may include a complex programmable logic device (CPLD), a field-programmable gate array (FPGA), a general array logic (GAL), or any combination thereof.

In some embodiments, the UAV can include one or more processors 110 working individually or collectively.

In some embodiments, the processor 110 can be configured, when the gimbal 200 passively rotates from the first position to the second position along the first direction, to calculate the difference between the joint angle of the gimbal 200 at the first position and the joint angle of the gimbal 200 at the second position, when the difference satisfies the first specific condition, to control the gimbal 200 to return to the first position from the second position by rotating along the direction opposite to the first direction, when the difference satisfies the second specific condition, according to the sub-region where the first position is located, to control the gimbal 200 to return to the first position from the second position by rotating along the shortest path or along the direction opposite to the first direction.

Consistent with the disclosure, when the gimbal 200 is passively triggered at the angle that cannot rotate 360 degrees to rotate from the first position to the second position, the automatic reset manner of the gimbal 200 can be selected according to the difference between the joint angle of the gimbal 200 at the first position and the joint angle of the gimbal 200 at the second position. The issue of the gimbal 200 colliding with the mechanical limits due to the shortest path problem can be avoided, such that the user confusion can be reduced and the user experience can be better.

In some embodiments, the first specific condition can include that the absolute value of the difference is less than or equal to 180 degrees. In some embodiments, the second specific condition can include that the absolute value of the difference is greater than 180 degrees. In some embodiments, the rotation region can be divided into the plurality of sub-regions according to the equal division principle.

In some embodiments, the rotation region of the gimbal can include the forward rotation region and the backward rotation region. The joint angle of the gimbal for the forward rotation region and the joint angle of the gimbal for the backward rotation region can be both greater than 180 degrees and less than 360 degrees. The rotation region can be divided into the plurality of the sub-regions according to the maximum joint angle position 201 of the forward rotation region, the maximum joint angle position 202 of the backward rotation region, and the rotation center of the gimbal 200. In some embodiments, the maximum joint angle position 201 of the forward rotation region, the maximum joint angle position 202 of the backward rotation region, and the rotation center of the gimbal 200 can be not collinear.

In some embodiments, the sub-region where the first position is located can be the sub-region between the line connecting the maximum joint angle position 201 of the forward rotation region and the rotation center and the line connecting the maximum joint angle position 202 of the backward rotation region and the rotation center, and the processor 110 can be configured to control the gimbal 200 to return to the first position from the second position by rotating along the direction opposite to the first direction.

In some embodiments, the sub-region where the first position is located can be the sub-region between the extension of the line connecting the maximum joint angle position 201 of the forward rotation region and the rotation center and the line connecting the maximum joint angle position 202 of the backward rotation region and the rotation center. When the joint angle of the gimbal 200 at the first position has the positive value, the processor 110 can be configured, if the first direction is the forward rotation direction, to control the gimbal 200 to return to the first position from the second position by rotating along the backward rotation direction, and if the first direction is the backward rotation direction, to control the gimbal 200 to return to the first position from the second position by rotating along the shortest path. When the joint angle of the gimbal 200 at the first position has the negative value, the processor 110 can be configured, if the first direction is the forward rotation direction, to control the gimbal 200 to return to the first position from the second position by rotating along the shortest path.

In some embodiments, the sub-region where the first position is located can be the sub-region between the line connecting the maximum joint angle position 201 of the forward rotation region and the rotation center and the extension of the line connecting the maximum joint angle position 202 of the backward rotation region and the rotation center. When the joint angle of the gimbal 200 at the first position has the positive value, the processor 110 can be configured, if the first direction is the backward rotation direction, to control the gimbal 200 to return to the first position from the second position by rotating along the shortest path. When the joint angle of the gimbal 200 at the first position has the negative value, the processor 110 can be configured, if the first direction is the forward rotation direction, to control the gimbal 200 to return to the first position from the second position by rotating along the shortest path, and if the first direction is the backward rotation direction, to control the gimbal 200 to return to the first position from the second position by rotating along the forward rotation direction.

In some embodiments, the sub-region where the first position is located can be the sub-region between the extension of the line connecting the maximum joint angle position 201 of the forward rotation region and the rotation center and the extension of the line connecting the maximum joint angle position 202 of the backward rotation region and the rotation center, and the processor 110 can be configured to control the gimbal 200 to return to the first position from the second position by rotating along the shortest path.

In some embodiments, the maximum joint angle position 201 of the forward rotation region, the maximum joint angle position 202 of the backward rotation region, and the rotation center of the gimbal 200 can be collinear. In some embodiments, the sub-region where the first position is located can be the portion where the forward rotation region and the backward rotation region do not overlap, and the processor 110 can be configured to control the gimbal 200 to return to the first position from the second position by rotating along the direction opposite to the first direction. In some embodiments, the sub-region where the first position is located can be the portion where the forward rotation region and the backward rotation region overlap, and the processor 110 can be configured to control the gimbal 200 to return to the first position from the second position by rotating along the shortest path.

In some embodiments, after the gimbal 200 to is controlled return to the first position from the second position by rotating along the shortest path, the direction of the joint angle of the gimbal 200 at the first position can be opposite from that of the gimbal 200 before passively rotating the gimbal 200 from the first position to the second position by rotating along the first direction.

In some embodiments, the processor 110 can be configured to control the gimbal 200 to return to the first position from the second position by rotating along the direction opposite to the first direction at the first preset speed. The first preset speed can be greater than 0°/s and less than 180°/s.

In some embodiments, the processor 110 can be configured to control the gimbal 200 to return to the first position by rotating along the shortest path at the second preset speed. The second preset speed can be greater than 0°/s and less than 180°/s.

In some embodiments, referring again to FIG. 11, the gimbal 200 includes the gimbal base 220 fixedly connected to the body. The processor 110 can be configured to determine the attitude of the gimbal base 220 and the attitude of the gimbal 200 at the first position, and determine the sub-region where the first position is located according to the attitude of the gimbal base 220 and the attitude of the gimbal 200 at the first position.

In some embodiments, the processor 110 can be configured to determine the rotational attitude of the gimbal base 220 at the first position according to the attitude of the gimbal base 220 and the attitude of the gimbal 200 at the first position, calculate the joint angle of the gimbal 200 at the first position according to the rotational attitude, and determine the sub-region where the first position is located according to the joint angle of the gimbal 200 at the first position and the plurality of sub-regions.

In some embodiments, the processor 110 can be configured to obtain the real-time attitude of the UAV at which the gimbal 200 is mounted, and determine the attitude of the gimbal base 220 according to the real-time attitude of the UAV. In some embodiments, the joint angle may include the yaw axis angle of the gimbal 200.

In some embodiments, the gimbal 200 can include the yaw axis, and the joint angle may include the yaw axis angle of the gimbal 200.

The implementation of the processor 110 is similar to that of the method in FIG. 3, and detailed description can be omitted herein.

In some embodiments, the processor 110 can be the flight controller of the UAV or a controller of the gimbal 200.

In some embodiments, the gimbal 200 may include a two-axis gimbal or a three-axis gimbal. Herein, takes a three-axis gimbal as an example of the gimbal 200 for further description. The shaft assembly 220 may include the yaw axis shaft, the roll axis shaft, and the pitch axis shaft. The shaft assembly 220 may further include the yaw axis motor for controlling the rotation about the yaw axis, the roll axis motor for controlling the rotation about the roll axis, and the pitch axis motor for controlling the rotation about the pitch axis. The yaw axis motor, the roll axis motor, and the pitch axis motor are electrically coupled to the flight controller, such that the flight controller can control the rotation of the yaw axis motor, the rotation of the roll axis motor, and the rotation of the pitch axis motor, thereby controlling the attitude of the three-axis gimbal 200.

As shown in FIG. 11, the gimbal 200 carries the load 300, and the load 300 may include an image acquisition device or an imaging device (e.g., a camera, a camcorder, an infrared camera device, an ultraviolet camera device, or the like), an audio acquisition device (e.g., parabolic reflector microphone), an infrared camera device, and/or the like. The load 300 may provide static sensing data (e.g., images) or dynamic sensing data (e.g., videos). The load 300 can be mounted at the carrier (e.g., the gimbal 200), such that the carrier can control the load 300 to rotate.

As shown in FIGS. 10 and 11, the UAV may include a power mechanism 500. The power mechanism 500 may include one or more rotating bodies, propellers, blades, motors, electronic governors, and the like. For example, each rotating body of the power mechanism 500 may include a self-tightening rotating body, a rotating body assembly, or other rotating body power device. In some embodiments, the UAV may include one or more power mechanisms 500. The one or more power mechanisms 500 may be of the same type or different types.

The power mechanism 500 may be mounted at the UAV by any suitable means, for example, through a supporting element (e.g., a driving shaft). The power mechanism 500 can be mounted at any suitable position of the UAV, such as a top end of the UAV, a lower end of the UAV, a front end of the UAV, a rear end of the UAV, a side of the UAV, or any combination thereof. A flight of the UAV can be controlled by controlling the one or more power mechanisms 500.

As shown in FIGS. 10 and 11, the UAV may be communicatively coupled to a terminal 400. In some embodiments, the terminal 400 can provide control data to one or more of the UAV, the carrier, and the load 300, and receive information (e.g., position and/or motion information of the UAV, the carrier, or the load 300, data sensed by the load 300, for example, image data captured by the camera) from one or more of the UAV, the carrier, and the load 300. In some embodiments, the UAV can be controlled by a remote controller.

In some embodiments, the UAV can communicate with other remote devices other than the terminal 400, and the terminal 400 can also communicate with other remote devices other than the UAV. For example, the UAV and/or terminal 400 may communicate with another UAV or the carrier or the load 300 of the another UAV. For example, another remote device may be a second terminal 400 or other computing device (e.g., a computer, a desktop computer, a tablet computer, a smart phone, or other mobile device). The another remote device may send data to the UAV, receive data from the UAV, send data to the terminal 400, and/or receive data from the terminal 400. In some embodiments, the another remote device may be connected to the Internet or other telecommunications network to upload the data received from the UAV and/or the terminal 400 to a web site or a server.

In some embodiments, a movement of the UAV, the carrier, or the load 300 relative to a fixed reference object (e.g., the external environment), and/or between each other, can be controlled by the terminal 400. The terminal 400 may be a remote control terminal 400, which is located away from the UAV, the carrier, and/or the load 300. The terminal 400 may be located or pasted on a support platform. In some embodiments, the terminal 400 may be handheld or wearable. For example, the terminal 400 may include a smartphone, a tablet computer, a desktop computer, a computer, glasses, gloves, a helmet, a microphone, or any combination thereof. The terminal 400 may include a user interface, such as a keyboard, a mouse, a joystick, a touch screen, or a display. Any suitable user input, for example, manually inputting instructions, a voice control, a gesture control, or a position control (e.g., through movement, position, or tilt of the terminal 400), may interact with the terminal 400.

The present disclosure further provides a computer-readable storage medium on which a computer program is stored, and when the computer program is executed by a processor, the processes of the method for controlling reset of the gimbal consistent with the disclosure (e.g., the method in FIG. 3) can be implemented.

Detailed descriptions of the operations of exemplary systems, devices, and units may be omitted and references can be made to the descriptions of the exemplary methods. The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure. Those skilled in the art can understand and implement without creative effort.

As used herein, the terms “certain example,” “some examples,” or the like, refer to that the specific features, structures, materials, or characteristics described in connection with the embodiments or examples are included in at least one embodiment or example of the disclosure. The illustrative representations of the above terms are not necessarily referring to the same embodiments or examples. Furthermore, the specific features, structures, materials, or characteristics described may be combined in a suitable manner in any one or more embodiments or examples.

The processes and/or methods described in the flowcharts or in other manners may be a module, a segment, or a portion of codes including one or more executable instructions for implementing specific logical functions or steps of the processes. It can be appreciated by those skilled in the art that the preferred embodiments of the present disclosure may include additional implementations that are performing functions in a substantially simultaneous manner or in a reverse order according to the functions involved.

The logics and/or processes described in the flowcharts or in other manners may be, for example, an order list of the executable instructions for implementing logical functions, which may be implemented in any computer-readable storage medium and used by an instruction execution system, apparatus, or device, such as a computer-based system, a system including a processor, or another system that can fetch and execute instructions from an instruction execution system, apparatus, or device, or used in a combination of the instruction execution system, apparatus, or device. The computer-readable storage medium may be any apparatus that can contain, store, communicate, propagate, or transmit the program for using by or in a combination of the instruction execution system, apparatus, or device. The computer readable medium may include, for example, an electrical assembly having one or more wires, e.g., electronic apparatus, a portable computer disk cartridge. e.g., magnetic disk, a random access memory (RAM), a read only memory (ROM), an erasable programmable read only memory (EPROM or flash memory), an optical fiber device, or a compact disc read only memory (CDROM). In addition, the computer readable medium may be a paper or another suitable medium upon which the program can be printed. The program may be obtained electronically, for example, by optically scanning the paper or another medium, and editing, interpreting, or others processes, and then stored in a computer memory.

Those of ordinary skill in the art will appreciate that the example elements and steps described above can be implemented in electronic hardware, computer software, firmware, or a combination thereof. Multiple processes or methods may be implemented in a software or firmware stored in the memory and executed by a suitable instruction execution system. When being implemented in an electronic hardware, the example elements and processes described above may be implemented using any one or a combination of: discrete logic circuits having logic gate circuits for implementing logic functions on data signals, specific integrated circuits having suitable combinational logic gate circuits, programmable gate arrays (PGA), field programmable gate arrays (FPGAs), and the like.

Some or all of the processes of the method described above can be executed by hardware running program instructions. The program may be stored in a computer-readable storage medium. When the program is executed, one or any combination of the processes of the method are executed.

In addition, the functional units in the various embodiments of the present disclosure may be integrated in one processing unit, or each unit may be an individual physically unit, or two or more units may be integrated in one unit. The integrated unit described above may be implemented in electronic hardware or computer software. The integrated unit may be stored in a computer readable medium, which can be sold or used as a standalone product.

The computer-readable storage medium can include a read-only memory (ROM), a magnetic disk, an optical disk, or the like. It is intended that the disclosed embodiments be considered as exemplary only and not to limit the scope of the disclosure. Changes, modifications, alterations, and variations of the above-described embodiments may be made by those skilled in the art within the scope of the disclosure.

What is claimed is:

1. A method for controlling reset of a gimbal comprising:
calculating a difference between a joint angle of the gimbal at a first position and a joint angle of the gimbal at a second position in response to the gimbal passively rotating from the first position to the second position along a passive rotation direction;
controlling the gimbal to return to the first position from the second position according to a first reset strategy in response to the difference satisfying a first condition, the first reset strategy including rotating the gimbal along a direction opposite to the passive rotation direction; and
controlling the gimbal to return to the first position from the second position according to a second reset strategy in response to the difference satisfying a second condition, the second reset strategy including rotating the gimbal along a shortest path or along the direction opposite to the passive rotation direction according to a target sub-region in which the first position is located;
wherein a rotation region of the gimbal has a joint angle range larger than 360 degrees, and the target sub-region is one of a plurality of sub-regions of the rotation region.

2. The method of claim 1, wherein:
the first condition includes an absolute value of the difference being less than or equal to 180 degrees; and
the second condition includes the absolute value of the difference being greater than 180 degrees.

3. The method of claim 1, wherein the rotation region is equally divided into the plurality of sub-regions.

4. The method of claim 1, wherein:
the rotation region includes a forward rotation region and a backward rotation region;
a maximum forward joint angle for the forward rotation region and a maximum backward joint angle for the backward rotation region are both greater than 180 degrees and less than 360 degrees; and
the rotation region is divided into the plurality of sub-regions according to a maximum forward joint angle position corresponding to the maximum forward joint angle, a maximum joint angle position corresponding to the maximum backward joint angle, and a rotation center of the gimbal.

5. The method of claim 4, wherein the maximum forward joint angle position, the maximum backward joint angle position, and the rotation center are not collinear.

6. The method of claim 5, wherein:
the target sub-region is between:
a line connecting the maximum forward joint angle position and the rotation center, and
a line connecting the maximum backward joint angle position and the rotation center; and
controlling the gimbal to return to the first position from the second position according to the second reset strategy includes controlling the gimbal to return to the first position from the second position by rotating along the direction opposite to the passive rotation direction.

7. The method of claim 5, wherein:
the target sub-region is between:
an extension of a line connecting the maximum forward joint angle position and the rotation center, and
a line connecting the maximum backward joint angle position and the rotation center; and
controlling the gimbal to return to the first position from the second position according to the second reset strategy includes:
in response to the joint angle of the gimbal at the first position having a positive value:
controlling the gimbal to return to the first position from the second position by rotating along a backward rotation direction in response to the passive rotation direction being a forward rotation direction; and
controlling the gimbal to return to the first position from the second position by rotating along the shortest path in response to the passive rotation direction being the backward rotation direction; and
in response to the joint angle of the gimbal at the first position having a negative value and the passive rotation direction being the forward rotation direction, controlling the gimbal to return to the first position from the second position by rotating along the shortest path.

8. The method of claim 5, wherein:
the target sub-region is a between:
a line connecting the maximum forward joint angle position and the rotation center, and
an extension of a line connecting the maximum backward joint angle position and the rotation center; and
controlling the gimbal to return to the first position from the second position according to the second reset strategy includes:
in response to the joint angle of the gimbal at the first position having a positive value and the passive rotation direction being a backward rotation direction, controlling the gimbal to return to the first position from the second position by rotating along the shortest path; and
in response to the joint angle of the gimbal at the first position having a negative value:
controlling the gimbal to return to the first position from the second position by rotating along the shortest path in response to the passive rotation direction being a forward rotation direction; and
controlling the gimbal to return to the first position from the second position by rotating along the forward rotation direction in response to the passive rotation direction being the backward rotation direction.

9. The method of claim 5, wherein:
the target sub-region is a between:
an extension of a line connecting the maximum forward joint angle position and the rotation center, and
an extension of a line connecting the maximum backward joint angle position and the rotation center; and
controlling the gimbal to return to the first position from the second position according to the second reset strategy includes controlling the gimbal to return to the first position from the second position by rotating along the shortest path.

10. The method of claim 4, wherein the maximum forward joint angle position, the maximum backward joint angle position, and the rotation center are collinear.

11. The method of claim 10, wherein controlling the gimbal to return to the first position from the second position according to the second reset strategy includes:
controlling the gimbal to return to the first position from the second position by rotating along the direction opposite to the passive rotation direction in response to the target sub-region belonging to only the forward rotation region or only the backward rotation region; and
controlling the gimbal to return to the first position from the second position by rotating along the shortest path in response to the target sub-region belonging to both the forward rotation region and the backward rotation region.

12. The method of claim 1, wherein a direction of the joint angle of the gimbal at the first position after the gimbal returns to the first position by rotating along the shortest path is opposite from a direction of the joint angle of the gimbal at the first position before the gimbal passively rotates from the first position to the second position.

13. The method of claim 1, wherein controlling the gimbal to return to the first position from the second position by rotating along the direction opposite to the passive rotation direction includes controlling the gimbal to return to the first position from the second position by rotating along the direction opposite to the passive rotation direction at a speed greater than 0°/s and less than 180°/s.

14. The method of claim 1, wherein controlling the gimbal to return to the first position from the second position by rotating along the shortest path includes controlling the gimbal to return to the first position by rotating along the shortest path at a speed greater than 0°/s and less than 180°/s.

15. The method of claim 1, further comprising:
determining an attitude of a gimbal base of the gimbal and an attitude of the gimbal at the first position; and
determining the target sub-region according to the attitude of the gimbal base and the attitude of the gimbal at the first position.

16. The method of claim 15, wherein determining the target sub-region according to the attitude of the gimbal base and the attitude of the gimbal at the first position includes:
determining a rotational attitude of the gimbal base at the first position according to the attitude of the gimbal base and the attitude of the gimbal at the first position;
calculating the joint angle of the gimbal at the first position according to the rotational attitude; and
determining the target sub-region from the plurality of sub-regions according to the joint angle of the gimbal at the first position.

17. The method of claim 15, wherein determining the attitude of the gimbal base includes:
obtaining a real-time attitude of an unmanned aerial vehicle (UAV) carrying the gimbal; and
determining the attitude of the gimbal base according to the real-time attitude of the UAV.

18. The method of claim 1, wherein the joint angle includes a yaw axis angle of the gimbal.

19. A device for controlling reset of a gimbal comprising:
one or more processors working individually or collectively; and
a storage device storing program instructions that, when being executed by the one or more processors, cause the one or more processors to:
calculate a difference between a joint angle of the gimbal at a first position and a joint angle of the gimbal at a second position in response to the gimbal passively rotating from the first position to the second position along a passive rotation direction;
control the gimbal to return to the first position from the second position according to a first reset strategy in response to the difference satisfying a first condition, the first reset strategy including rotating the gimbal along a direction opposite to the passive rotation direction; and
control the gimbal to return to the first position from the second position according to a second reset strategy in response to the difference satisfying a second condition, the second reset strategy including rotating the gimbal along a shortest path or along the direction opposite to the passive rotation direction according to a target sub-region in which the first position is located;
wherein a rotation region of the gimbal has a joint angle range larger than 360 degrees, and the reset beginning sub-region is one of a plurality of sub-regions of the rotation region.

20. A gimbal comprising:
a shaft assembly; and
one or more processors electrically coupled to the shaft assembly and configured to, individually or collectively:
calculate a difference between a joint angle of the gimbal at a first position and a joint angle of the gimbal at a second position in response to the gimbal passively rotating from the first position to the second position along a passive rotation direction;
control the gimbal to return to the first position from the second position according to a first reset strategy in response to the difference satisfying a first condition, the first reset strategy including rotating the gimbal along a direction opposite to the passive rotation direction; and
control the gimbal to return to the first position from the second position according to a second reset strategy in response to the difference satisfying a second condition, the second reset strategy including rotating the gimbal along a shortest path or along the direction opposite to the passive rotation direction according to a target sub-region in which the first position is located;
wherein a rotation region of the gimbal has a joint angle range larger than 360 degrees, and the reset beginning sub-region is one of a plurality of sub-regions of the rotation region.
